(19) United States
(12) Patent Application Publication
(10) Pub. No.: US 2014/0111670 A1
(43) Pub. Date: Apr. 24, 2014

(54) SYSTEM AND METHOD FOR ENHANCED IMAGE CAPTURE

(71) Applicant: NVIDIA CORPORATION, Santa Clara, CA (US)

(72) Inventors: Nathan Lord, Santa Clara, CA (US); Patrick Shehane, Fremont, CA (US)

(73) Assignee: NVIDIA CORPORATION, Santa Clara, CA (US)

(21) Appl. No.: 13/658,117

(22) Filed: Oct. 23, 2012

(51) Int. Cl. H04N 5/262; H04N 5/225

(52) U.S. Cl. 348/240.99; 348/207.99; 348/E05.051; 348/E05.024

(57) ABSTRACT

A system and method for image capture. The method includes configuring an image sensor to capture at a full resolution of the image sensor and automatically capturing a first image with the image sensor irrespective of a shutter button of a camera. The method further includes receiving an image capture request and accessing a second image after the receiving of the image capture request. The first image is captured prior to the receiving of the image capture request. The first image and the second image may then be stored.

### FIELD OF THE INVENTION

Embodiments of the present invention are generally related to image capture.

### BACKGROUND OF THE INVENTION

As computer systems have advanced, processing power and speed have increased substantially. At the same time, the processors and other computer components have decreased in size allowing them to be part of an increasing number of devices. Cameras and mobile devices have benefited significantly from the advances in computing technology. The addition of camera functionality to mobile devices has made taking photographs and video quite convenient.

The timing of the image capture can be critical to capturing the right moment. If a user presses a shutter button to capture an image too early or too late the intended picture may be missed. For example, hesitation of a user in pressing the shutter button while at a sporting event could result in missing a key play of the game, such as a goal in soccer.

The timing of the capture of an image may also be impacted by the speed of the camera. A request from the shutter button may go through a software stack having a corresponding delay or latency before reaching hardware which also has a corresponding delay. The hardware delay may be partially caused by delay in reading the pixels of a camera sensor. Thus, even if the user is able to press the shutter button at the desired moment in time, the delay of the camera may result in capturing an image too late thereby missing the desired shot. Conventional solutions have focused on making image capture faster by reducing the delay after the time the shutter button is pressed. Unfortunately, while a faster camera may have a reduced delay, this fails to solve issues related to the timing of the shutter button press and the delay from the camera is still present.

Thus, a need exists for a solution to allow capture of an image at the desired moment irrespective of device hardware delays or timing of a shutter button press.

### SUMMARY OF THE INVENTION

Embodiments of the present invention are operable to continually capture full resolution images, irrespective of a shutter button of a camera, to memory such that when a user presses or pushes a shutter button, images that have been captured prior to the shutter button press are available for a user to select and save (e.g., to storage). A user thereby has access to images captured prior to the shutter button press and thereby can overcome reaction time delays and device delays (e.g., software and hardware delays). Embodiments of the present invention are further operable to provide images that are captured after the shutter button press (e.g., a burst of images). Embodiments of the present invention are also operable to allow a user to navigate and select images that were captured before and after the shutter button press. Embodiments of the present invention thus allow a user to select the most desired image(s) captured before and after the shutter button press.

In one embodiment, the present invention is directed toward a method for image capture. The method includes configuring an image sensor to capture at a full resolution of the image sensor and automatically capturing a first image with the image sensor irrespective of a shutter button of a camera. In one embodiment, the first image is stored in a circular buffer. The method further includes receiving an image capture request and accessing a second image after the receiving of the image capture request. The first image is captured prior to the receiving of the image capture request. The image capture request may be based on a shutter button press, received from a camera application, or received via an application programming interface (API). The first image and the second image may then be stored. The method may further include displaying the first image and the second image in a graphical user interface. In one embodiment, the graphical user interface is operable to allow selection of the first image and the second image for storage. The method may further include scaling the first image to a preview resolution where the preview resolution is less than the full resolution of the image sensor.

In one embodiment, the present invention is implemented as a system for image capture. The system includes an image sensor configuration module operable to configure an image sensor to capture at a full resolution of the image sensor and an image capture request module operable to receive an image capture request. The image capture request module is operable to receive the image capture request from a shutter button, from an application (e.g., camera application), or an application programming interface (API). The system further includes an image sensor control module operable to signal the image sensor to automatically capture a first image irrespective of a shutter button of a camera. In one embodiment, the first image is stored in a buffer. The image sensor control module is further operable to signal the image sensor to capture a second image, where the first image is captured prior to the image capture request. The system may further include an image selection module operable to generate of a graphical user interface operable for selection of the first image and the second image for at least one of storage and deletion. The system may further include a scaling module operable to scale the first image and the second image to a second resolution, where the second resolution is lower than the full resolution of the sensor.

In another embodiment, the present invention is directed to a computer-readable storage medium having stored thereon, computer executable instructions that, if executed by a computer system cause the computer system to perform a method of capturing a plurality of images. The method includes automatically capturing a first plurality of images with an image sensor operating in a full resolution configuration and receiving an image capture request. The capturing of the first plurality of images is irrespective of a shutter button of a camera. The first plurality of images is captured prior to receiving the image capture request. In one embodiment, the first plurality of images is captured continuously and stored in a circular buffer. In one exemplary embodiment, the number of images in the first plurality of image is configurable (e.g., by a user). The method further includes accessing a second plurality of images after the image capture request and displaying the first plurality of images and the second plurality of images. The image capture request may be based on a shutter button press, received from a camera application, or received via an application programming interface (API). In one embodiment, the first plurality of images and the second plurality of images are displayed in a graphical user interface operable to allow selection of each image of the first plurality of images and the second plurality of images for storage.

### BRIEF DESCRIPTION OF THE DRAWINGS

Embodiments of the present invention are illustrated by way of example, and not by way of limitation, in the figures of the accompanying drawings and in which like reference numerals refer to similar elements.

FIG. 1 shows a computer system in accordance with one embodiment of the present invention.

FIG. 2 shows an exemplary operating environment in accordance with one embodiment of the present invention.

FIG. 3 shows a flowchart of a conventional process for image capture.

FIG. 4 shows a block diagram of exemplary components of a system for preview image and image capture in accordance with an embodiment of the present invention.

FIG. 5 shows a flowchart of an exemplary electronic component controlled process for image capture in accordance with one embodiment of the present invention.

FIG. 6 shows an exemplary time line of exemplary image captures in accordance with one embodiment of the present invention.

FIG. 7 shows a diagram of an exemplary graphical user interface for image capture and capture configuration in accordance with an embodiment of the present invention.

FIG. 8 shows a diagram of an exemplary post-capture review graphical user interface in accordance with an embodiment of the present invention.

FIG. 9 shows a block diagram of another exemplary post-capture review graphical user interface in accordance with an embodiment of the present invention.

FIG. 10 shows a block diagram of exemplary computer system and corresponding modules, in accordance with one embodiment of the present invention.

### DETAILED DESCRIPTION OF THE INVENTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail as not to unnecessarily obscure aspects of the embodiments of the present invention.

### Notation and Nomenclature:

Some portions of the detailed descriptions, which follow, are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

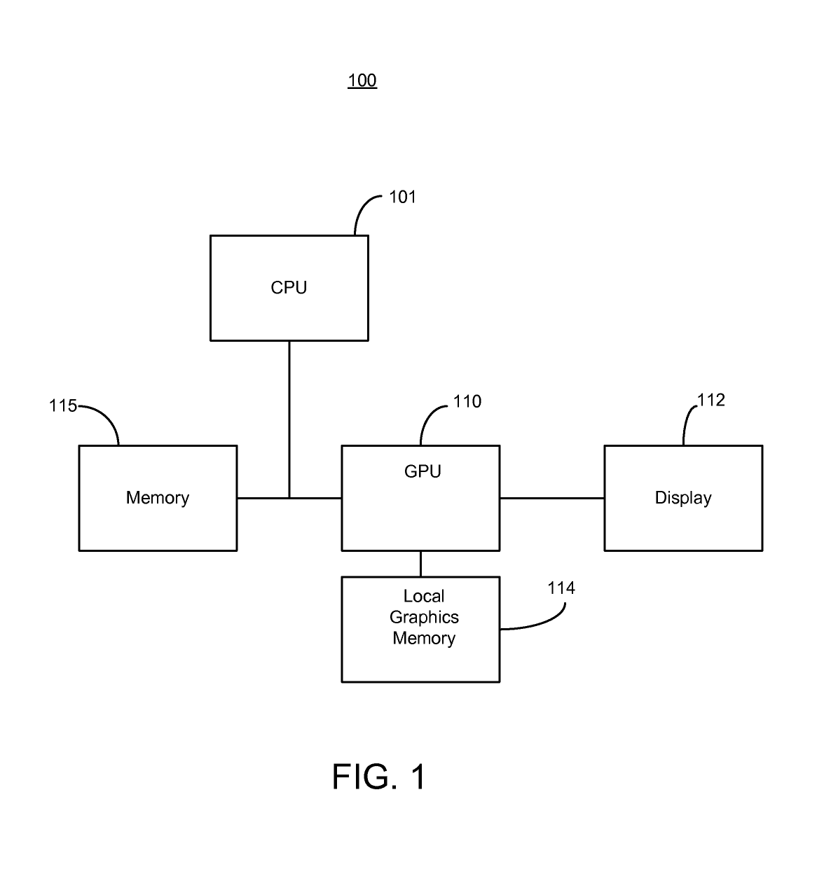

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of an integrated circuit (e.g., computing system 100 of FIG. 1), or similar electronic computing device, that manipulates and transforms data represented as physical (electronic) quantities within the computer system's registers and memories into other data similarly represented as physical quantities within the computer system memories or registers or other such information storage, transmission or display devices.

### Computer System Environment

FIG. 1 shows an exemplary computer system 100 in accordance with one embodiment of the present invention. FIG. 1 depicts an embodiment of a computer system operable to interface with an image capture apparatus (e.g., camera) and provide functionality as described herein. Computer system 100 depicts the components of a generic computer system in accordance with embodiments of the present invention providing the execution platform for certain hardware-based and software-based functionality. In general, computer system 100 comprises at least one CPU 101, a system memory 115, and at least one graphics processor unit (GPU) 110. The CPU 101 can be coupled to the system memory 115 via a bridge component/memory controller (not shown) or can be directly coupled to the system memory 115 via a memory controller (not shown) internal to the CPU 101. The GPU 110 may be coupled to a display 112. One or more additional GPUs can optionally be coupled to system 100 to further increase its computational power. The GPU(s) 110 is coupled to the CPU 101 and the system memory 115. The GPU 110 can be implemented as a discrete component, a discrete graphics card designed to couple to the computer system 100 via a connector (e.g., AGP slot, PCI-Express slot, etc.), a discrete integrated circuit die (e.g., mounted directly on a motherboard), or as an integrated GPU included within the integrated circuit die of a computer system chipset component (not shown). Additionally, a local graphics memory 114 can be included for the GPU 110 for high bandwidth graphics data storage.

The CPU 101 and the GPU 110 can also be integrated into a single integrated circuit die and the CPU and GPU may share various resources, such as instruction logic, buffers, functional units and so on, or separate resources may be provided for graphics and general-purpose operations. The GPU may further be integrated into a core logic component. Accordingly, any or all the circuits and/or functionality described herein as being associated with the GPU 110 can also be implemented in, and performed by, a suitably equipped CPU 101. Additionally, while embodiments herein may make reference to a GPU, it should be noted that the described circuits and/or functionality can also be implemented and other types of processors (e.g., general purpose or other special-purpose coprocessors) or within a CPU.

System 100 can be implemented as, for example, a desktop computer system or server computer system having a powerful general-purpose CPU 101 coupled to a dedicated graphics rendering GPU 110. In such an embodiment, components can be included that add peripheral buses, specialized audio/video components, IO devices, and the like. Similarly, system 100 can be implemented as a handheld device (e.g., cellphone, smartphone, etc.), direct broadcast satellite (DBS)/terrestrial set-top box or a set-top video game console device such as, for example, the Xbox®, available from Microsoft Corporation of Redmond, Wash., or the PlayStation3®, available from Sony Computer Entertainment Corporation of Tokyo, Japan. System 100 can also be implemented as a “system on a chip”, where the electronics (e.g., the components 101, 115, 110, 114, and the like) of a computing device are wholly contained within a single integrated circuit die. Examples include a hand-held instrument with a display, a car navigation system, a portable entertainment system, and the like.

### Exemplary Operating Environment:

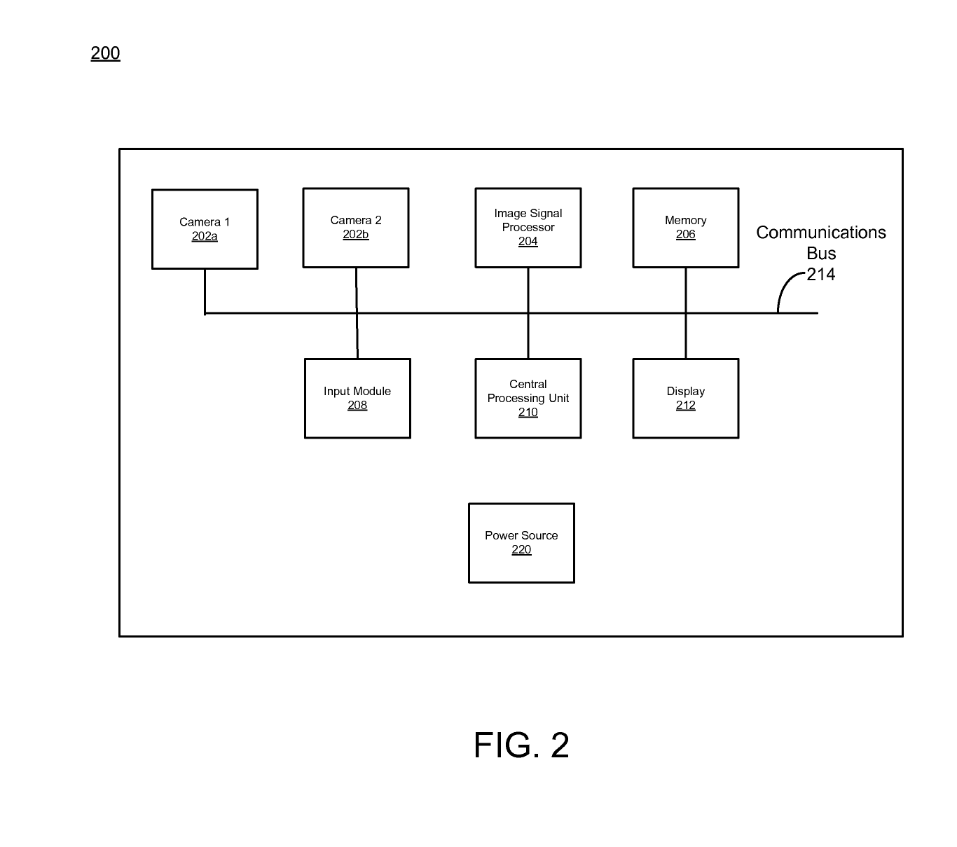

FIG. 2 shows an exemplary operating environment or “device” in accordance with one embodiment of the present invention. System 200 includes cameras 202a-b, image signal processor (ISP) 204, memory 206, input module 208, central processing unit (CPU) 210, display 212, communications bus 214, and power source 220. Power source 220 provides power to system 200 and may be a DC or AC power source. System 200 depicts the components of a basic system in accordance with embodiments of the present invention providing the execution platform for certain hardware-based and software-based functionality. Although specific components are disclosed in system 200, it should be appreciated that such components are examples. That is, embodiments of the present invention are well suited to having various other components or variations of the components recited in system 200. It is appreciated that the components in system 200 may operate with other components other than those presented, and that not all of the components of system 200 may be required to achieve the goals of system 200.

CPU 210 and the ISP 204 can also be integrated into a single integrated circuit die and CPU 210 and ISP 204 may share various resources, such as instruction logic, buffers, functional units and so on, or separate resources may be provided for image processing and general-purpose operations. System 200 can be implemented as, for example, a digital camera, cell phone camera, portable device (e.g., audio device, entertainment device, handheld device), webcam, video device (e.g., camcorder) and the like.

In one embodiment, cameras 202a-b capture light via a first lens and a second lens (not shown), respectively, and convert the light received into a signal (e.g., digital or analog). Camera 202b may be optional. Cameras 202a-b may comprise any of a variety of optical sensors including, but not limited to, complementary metal-oxide-semiconductor (CMOS) or charge-coupled device (CCD) sensors. Cameras 202a-b are coupled to communications bus 214 and may provide image data received over communications bus 214. Cameras 202a-b may each comprise respective functionality to determine and configure respective optical properties and settings including, but not limited to, focus, exposure, color or white balance, and areas of interest (e.g., via a focus motor, aperture control, etc.).

Image signal processor (ISP) 204 is coupled to communications bus 214 and processes the signal generated by cameras 202a-b, as described herein. More specifically, image signal processor 204 may process data from sensors of cameras 202a-b for storing in memory 206. For example, image signal processor 204 may compress and determine a file format for an image to be stored in within memory 206.

Input module 208 allows entry of commands into system 200 which may then, among other things, control the sampling of data by cameras 202a-b and subsequent processing by ISP 204. Input module 208 may include, but is not limited to, navigation pads, keyboards (e.g., QWERTY), up/down buttons, touch screen controls (e.g., via display 212) and the like.

Central processing unit (CPU) 210 receives commands via input module 208 and may control a variety of operations including, but not limited to, sampling and configuration of cameras 202a-b, processing by ISP 204, and management (e.g., addition, transfer, and removal) of images and/or video from memory 206.

### Exemplary Systems and Methods for Enhanced Image Capture

Embodiments of the present invention are operable to continually capture full resolution images, irrespective of a shutter button of a camera, to memory such that when a user presses or pushes a shutter button, images that have been captured prior to the shutter button press are available for a user to select and save (e.g., to storage). A user thereby has access to images captured prior to the shutter button press and thereby can overcome reaction time delays and device delays (e.g., software and hardware delays). Embodiments of the present invention are further operable to provide images that are captured after the shutter button press (e.g., a burst of images). Embodiments of the present invention are also operable to allow a user to navigate and select images that were captured before and after the shutter button press. Embodiments of the present invention thus allow a user to select the most desired image(s) captured before and after the shutter button press.

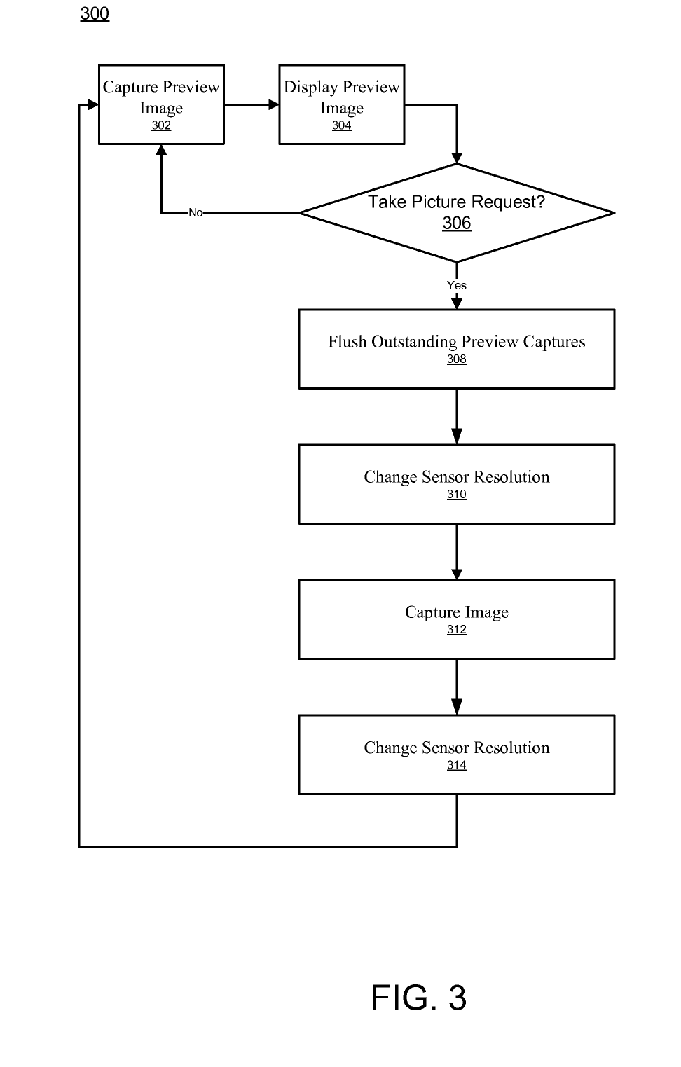

FIG. 3 shows a flowchart of a conventional process for image capture. Flowchart 300 depicts a conventional process for image capture with shutter lag or delay due to the image capture device. It is noted that blocks 308-312 add up to shutter lag or delay between the press of the shutter button and the capture of an image which can cause a user to miss the desired shot or image capture.

At block 302, a preview image is captured at a lower resolution than the full resolution of an image sensor. It is noted that conventional solutions operate the sensor at a lower resolution than the full resolution and the lower resolution allows sustaining of the preview frame rate of, for example, 30 fps. At block 304, the preview image is displayed.

At block 306, whether a take picture request has been received is determined. The picture request may be received if the user has pressed the shutter button. If a take picture request has not been received, block 302 is performed. If a take picture request is received, block 308 is performed.

At block 308, outstanding preview captures are flushed. The device completes the currently pending preview captures at the low resolution.

At block 310, sensor resolution is changed. The resolution of the sensor is changed to full resolution that the sensor is capable. The device waits for the new resolution settings to take effect.

At block 312, an image is captured at the new resolution. At block 314, sensor resolution is changed back to a preview resolution that is lower than the full resolution of the sensor.

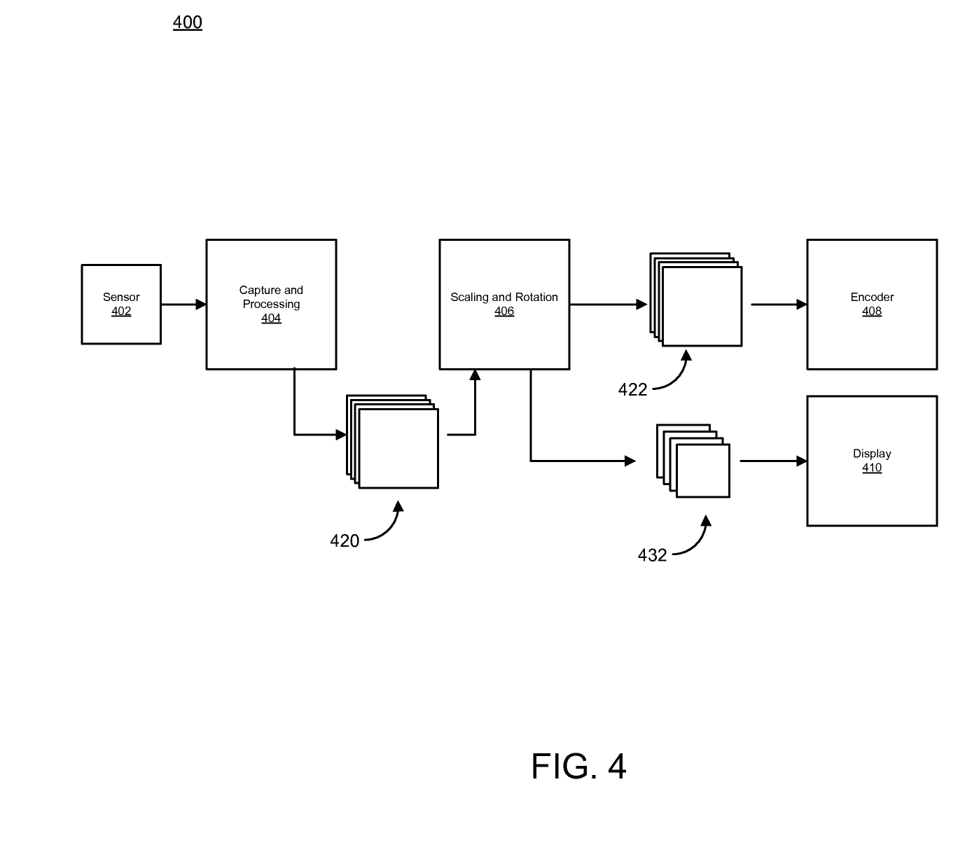

FIG. 4 shows a block diagram of exemplary components of a system for preview image and image capture in accordance with an embodiment of the present invention. FIG. 4 depicts full resolution image and full resolution preview image capture where images are captured prior to and after a shutter button press or take picture request. The full resolution images are stored in a buffer for selection by a user after the user presses a shutter button or take picture button. Exemplary system 400 includes sensor 402, capture and processing module 404, scaling and rotation module 406, encoder 408, display 410, buffers 420-422, and buffers 432. System 400 may be operable to generate simultaneous downscaled preview streams and full resolution streams.

Sensor 402 is operable to capture light and may be part of a camera (e.g., camera 202a) at full resolution. Sensor 402 is operable to capture full resolution images at high speed (e.g., 20 fps, 24 fps, 30 fps, or higher). The full resolution images may be operable for use as preview images and full resolution capture images or video.

In one embodiment, Sensor 402 is operable to capture preview frames at full resolution (e.g., continually) into a circular buffer or buffers (e.g., buffers 420). In one embodiment, the number of buffers is selected to optimize the tradeoffs of memory usage and performance. When a request is made to capture an image, the buffered full resolution frames (e.g., from buffers 420) are sent (e.g., through scaling and rotation 406) to encoder 408 and/or up to the camera application. Embodiments of the present invention thereby avoid delays due to changing the resolution of the sensor between a lower preview resolution and a higher image capture resolution.

Sensor 402 is coupled to capture and processing module 404 and sensor 402 sends captured image data or pixel values to capture and processing module 404. For example, sensor 402 may be operable to continually capture full resolution images (e.g., 8 Megapixels (MP) or 12 MP at 20 fps or 30 fps) which are processed by capture and processing module 404 and stored in buffer 420.

Scaling and rotation module 406 is operable to access the full resolution image buffers 420. Scaling and rotation module 406 is operable to generate downscaled preview images which are stored in buffers 432. Scaling and rotation module 406 is operable to generate scaled and rotated full size images which is stored in buffer 422. Scaling and rotation module 406 is further operable to generate scaled and rotated preview images which are stored in buffers 432.

Display 410 may display preview images to a user by accessing the preview images in buffers 432. Encoder 408 may access full resolution images from buffers 422 for encoding of full resolution images to a particular format (e.g., JPEG (Joint Photographic Experts Group), PNG (Portable Network Graphics), GIF (Graphics Interchange Format), TIFF (Tagged Image File Format), etc.). In one embodiment, upon a shutter button press or a picture request, the buffered full resolution images in buffers 420 are sent (e.g., through scaling and rotation 406) to encoder 408.

In one embodiment, a camera driver is implemented to control allocation of a number of image buffers, fill the buffers with full resolution still captures while simultaneously rendering a preview stream, and process a capture command that specifies how many and which of the buffers to send to the encoder. As the buffers (e.g., buffers 420) are filled before the capture request is received by the camera driver, the buffers that get sent to the encoder exist in “negative” time relative to the capture request. Embodiments of the present invention thereby allow camera applications to compensate for user reaction time, software/hardware device latency or delay, and other general time considerations that might be required when taking a picture in certain situations.

Some embodiments of the present invention are operable for use with the OpenMAX IL API. In one embodiment, a driver provides APIs which allow an application to select how many images to capture before and after the shutter button press and how to displays the captured images.

Embodiments of the present invention thus provide the ability to acquire full resolution still image captures reaching back a negative length in time from the time of the shutter button press. It is noted that, in one embodiment, the length of time may be limited only the by the memory capacity of the system.

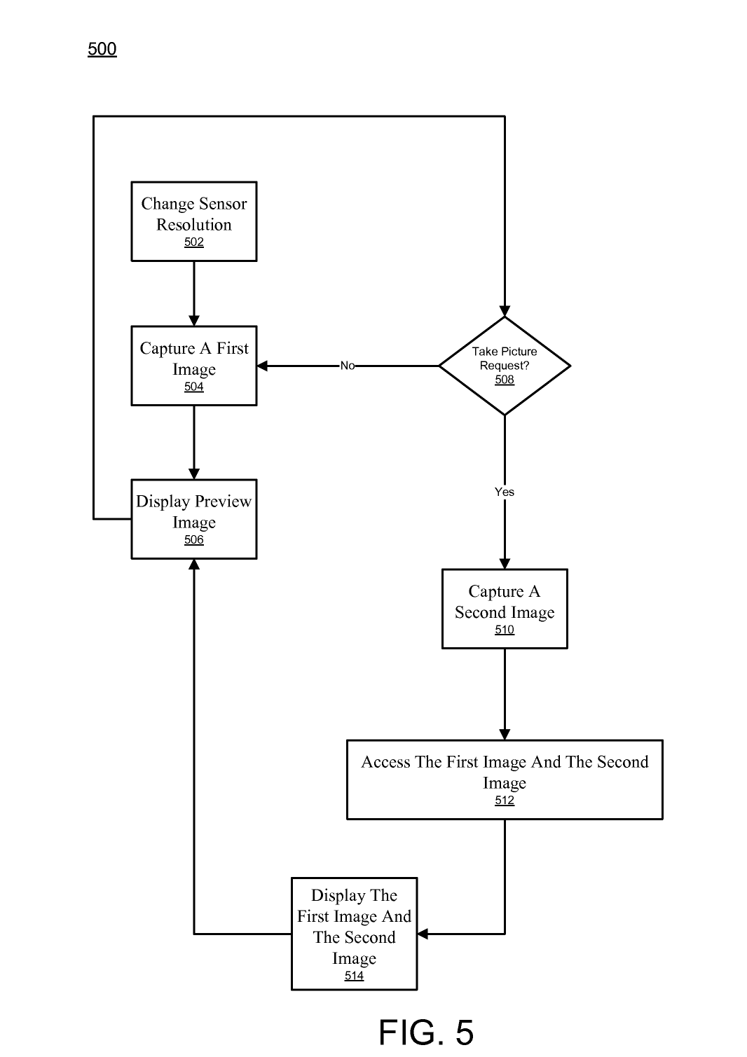

With reference to FIG. 5, flowchart 500 illustrates example functions used by various embodiments of the present invention. Although specific function blocks (“blocks”) are disclosed in flowchart 500, such steps are examples. That is, embodiments are well suited to performing various other blocks or variations of the blocks recited in flowchart 500. It is appreciated that the blocks in flowchart 500 may be performed in an order different than presented, and that not all of the blocks in flowchart 500 may be performed.

FIG. 5 shows a flowchart of an exemplary electronic component controlled process for image capture in accordance with one embodiment of the present invention. FIG. 5 depicts a preview image capture and full resolution capture process using a sensor operating at full resolution. Embodiments of the present invention may include an image sensor operable to sustain full resolution capture at a rate suitable for capturing preview images (e.g., 20, 24, 30, or higher frames per second (fps)). It is noted the process 500 avoids the processes of flushing preview requests (e.g., block 308) and changing the sensor resolution (e.g., blocks 310 and 314). It is appreciated that the buffering of image captures irrespective of a shutter button press and prior to the shutter button press allows delivery of images to a user that is faster and closer to when a user presses the shutter button. In one embodiment, images are captured at a predetermined interval continually and the images captured are presented to a user after an image capture request (e.g., shutter button press). Process 500 may be performed after automatic calibration of image capture settings (e.g., aperture settings, shutter speed, focus, exposure, color balance, and areas of exposure). Embodiments of the present invention may include command queues which allow multiple capture requests to be in flight to reduce the influence of other CPU activity.

Process 500 may be started upon the power on of a device (e.g., camera) or entry or launch of a camera application (e.g., on a smartphone). For example, a process 500 may be executed upon a user pressing a power button while a camera device is in the user's pocket and full resolution images will be captured and buffered for later selection by a user (e.g., after a shutter button press). Embodiments of the present invention thereby allow capture of images that may or may not be fully calibrated (e.g., focus, exposure, color balance, areas of interest, stabilization based on a gyroscope or accelerometer, etc.) but are the user's desired image which may then be processed or corrected later (e.g., with a post processing image application). In another embodiment, process 500 or portions thereof may be executed upon receiving a signal from a motion sensor (e.g., a gyroscope) indicating that stabilization of the image capture device (e.g., camera device or smartphone).

At block 502, the sensor resolution is changed. The sensor resolution may be changed or configured to full resolution (e.g., out of a preview or lower resolution). In one embodiment, the sensor resolution is set or reprogrammed to the full resolution upon the activating of a camera or launching of a camera application. In another embodiment, the sensor resolution is set to full resolution upon entering a pre-shutter or negative shutter lag (NSL) capture mode (e.g., beginning in a regular capture mode and then performing blocks 502-514 and then performing blocks 502-514 in response to some user or application input).

At block 504, a first image is captured (e.g., automatically at a full image sensor resolution). The first image may be captured irrespective of a shutter button of a camera (e.g., without or irrespective of a shutter button press). The image may be one of a plurality of full resolution image captures, as described herein, which are stored to one of a plurality buffers (e.g., circular buffers). In one embodiment, a first plurality of images or burst of images (e.g., a plurality of images captured in succession in a short period of time) may be captured. In one embodiment, the images captured may be selected to be stored to the buffers based on having calibrated optical properties (e.g., focus, exposure, color balance, areas of interest, stabilization based on a gyroscope or accelerometer). For example, the buffers could store the three most recently captured images that were properly focused (e.g., based on an auto focus algorithm). In one exemplary embodiment, a plurality of images are captured continuously and stored (e.g., selectively) in a circular buffer, as described herein.

At block 506, a preview image is displayed. The preview image may be a scaled down version of a full resolution image captured by an image or camera sensor. In one embodiment, the preview image is received or accessed from a circular buffer (e.g., buffers 432). The preview may run at the full resolution frame rate (e.g., 24, 30, or higher frames per second (fps)). The images captured may be scaled to a preview resolution where the preview resolution is less than the full resolution of the image sensor (e.g., scaled to the resolution of the display of the device).

At block 508, whether a take picture or image capture request has been received is determined. The image capture request may be based on a shutter button press, a camera application request, or application programming interface (API) request. The first image or first plurality of images may be captured prior to the receiving an image capture request. If a take picture request has not been received, block 504 is performed. If a take picture request is received, block 510 is performed.

At block 510, a second image or second plurality of images is accessed. The second image or the second plurality of images may be automatically captured irrespective of a shutter button of a camera (e.g., without or irrespective of a shutter button press). The second image may be one of a plurality of full resolution image captures, as described herein, which are stored to one of a plurality of buffers (e.g., circular buffers). In one exemplary embodiment, the number of images in the first plurality of images and the number of images the second plurality of images is configurable (e.g., user configurable via graphical user interface 700). In one embodiment, the images captured during blocks 504 and 510 may be selected to be stored to the buffers based on having calibrated optical properties (e.g., focus, exposure, color balance, areas of interest, stabilization based on a gyroscope or accelerometer). For example, the buffers could store the three most recently captured images that were properly focused.

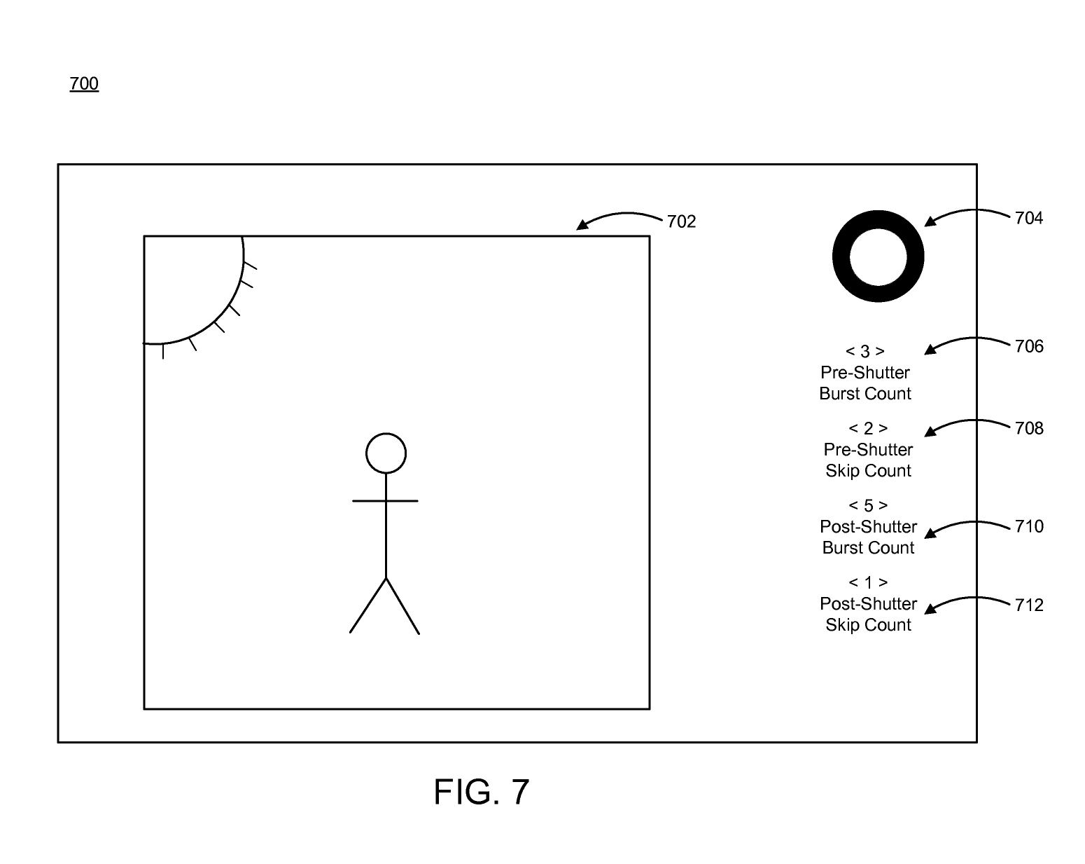

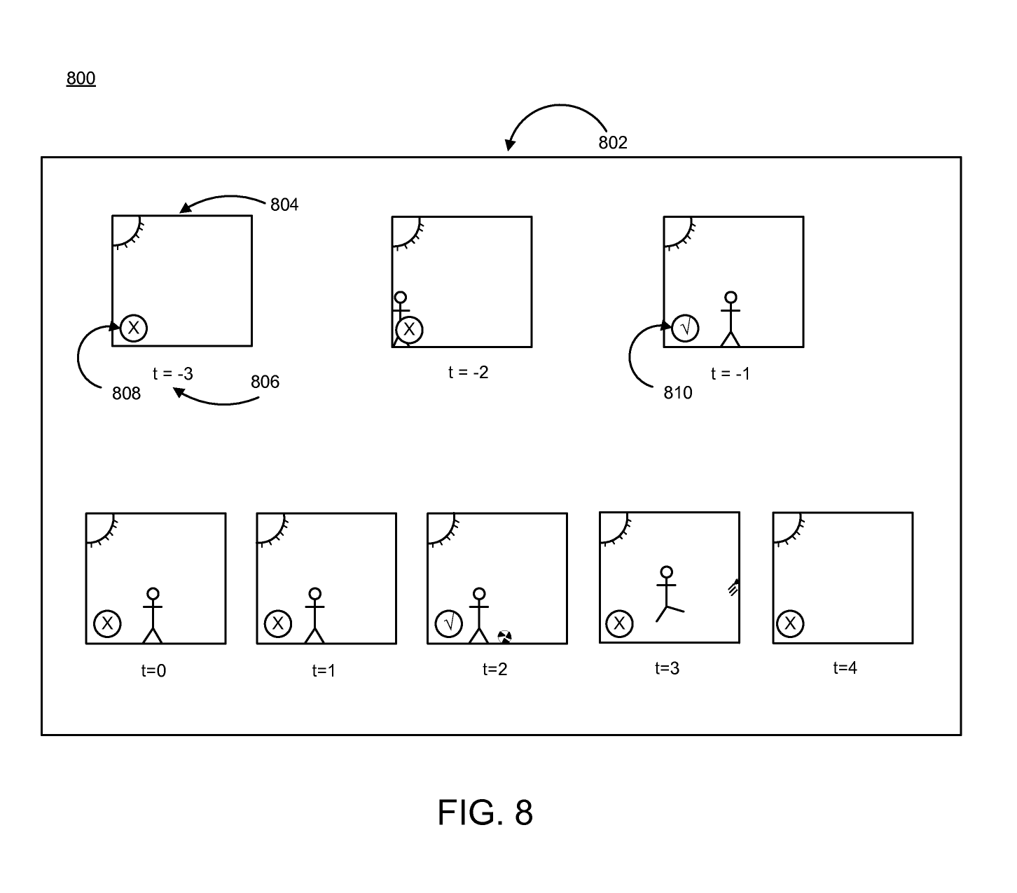

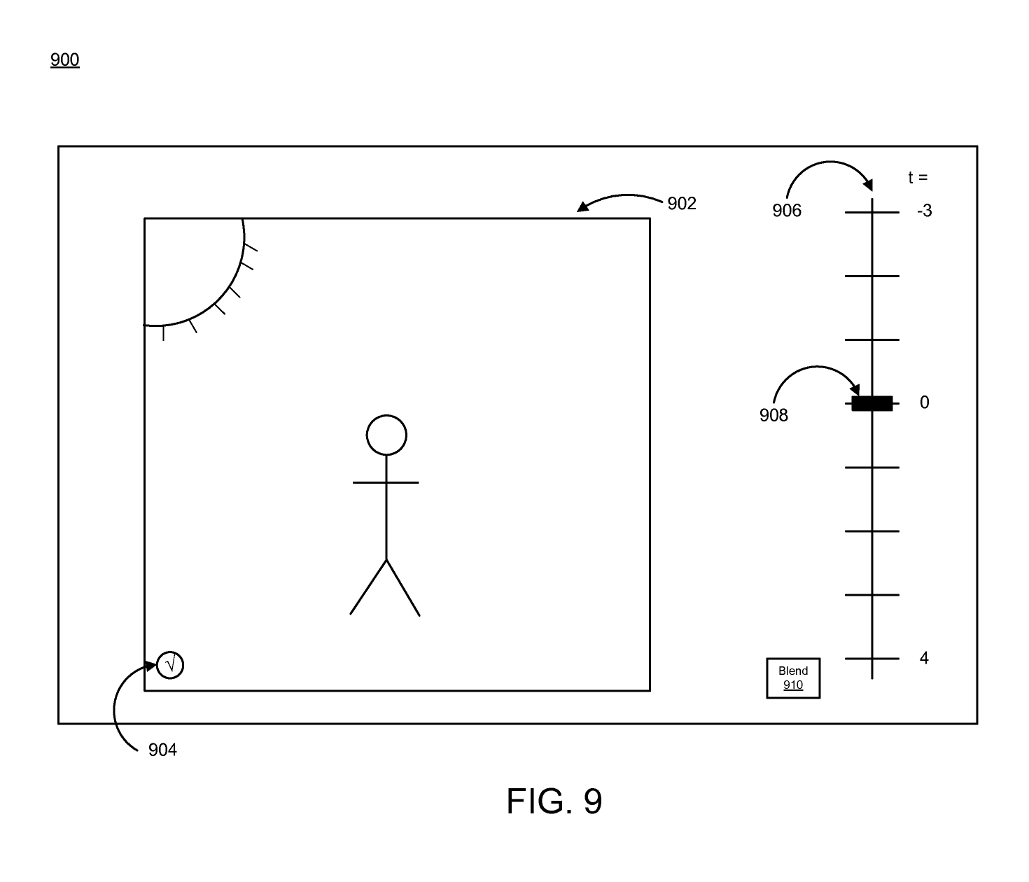

At block 512, the first image and the second image are accessed. The first and second image may be sent to storage (e.g., memory card) or sent to the encoder (e.g., prior to be sent to storage). In one embodiment, the last N images from a circular buffer (e.g., buffers 420) are sent (e.g., through scaling and rotation 406) to an encoder (e.g., encoder 408). The value of N corresponding to the number of images buffered may be configurable user setting or a default value (e.g., via a graphical user interface of FIG. 7). The value of N may be are accessed during entering of a negative shutter lag mode, as described herein. After the last N images are sent to the encoder, a user may select which of the N images to save or keep via a graphical user interface (e.g., FIGS. 8-9). In another embodiment, the first N frames of a burst of images are sent to the encoder. Any remaining frames are sent as soon as the frames are captured (e.g., captures of a burst after or in response to a shutter button press).

Viewing of preview images (e.g., block 506) may be interrupted for review of the image(s) captured (e.g., graphical user interfaces of FIGS. 8 and 9 may be presented). Capturing components (e.g., hardware and software) may continue to operate capturing full resolution images and storing to full resolution sized buffers (e.g., buffers 420) and preview buffers (e.g., buffers 432) while a negative shutter lag mode is set or enabled.

In one embodiment, the Android operating system, available from Google Corporation of Mountain View, Calif., specifies that preview images stop being captured when the takePicture( ) function is called, and preview image capture remains stopped until the startPreview( ) function is called to restart the preview mode. The startPreview( ) function may thus be called after selection of the captured images for storage (e.g., via graphical user interfaces 800-900).

In one embodiment, process 500 may be performed by one of two cameras of a two camera device (e.g., capable of stereo image capture or 3D). In another embodiment, process 500 may be used to composite images together. For example, a user may be trying to take a picture in a popular tourist location and at the last moment before the user presses the shutter button, a passerby walks into the picture. The images captured with process 500 prior to the user pressing the shutter button can be composited or merged with the image(s) captured after the shutter button press to allow a user to save a picture of the tourist location without the passerby in the resulting image. Process 500 thus allows merging of several images captured before the shutter button press along with the images captured after the shutter button press. Process 500 thereby allows the user to capture fewer images to reconstruct the necessary unobstructed portions than if the user had to manually capture and consider how many images would be necessary to form the desired composite image.

At block 514, the first image and the second image are displayed. The first and the second images may be displayed in a graphical user interface operable to allow selection of the first image and the second image for storage (e.g., via a graphical user interface 800-900). In one exemplary embodiment, a first plurality of images and a second plurality of images are displayed in graphical user interface operable to allow individual selection of each image of the first plurality of images and the second plurality of images for storage.

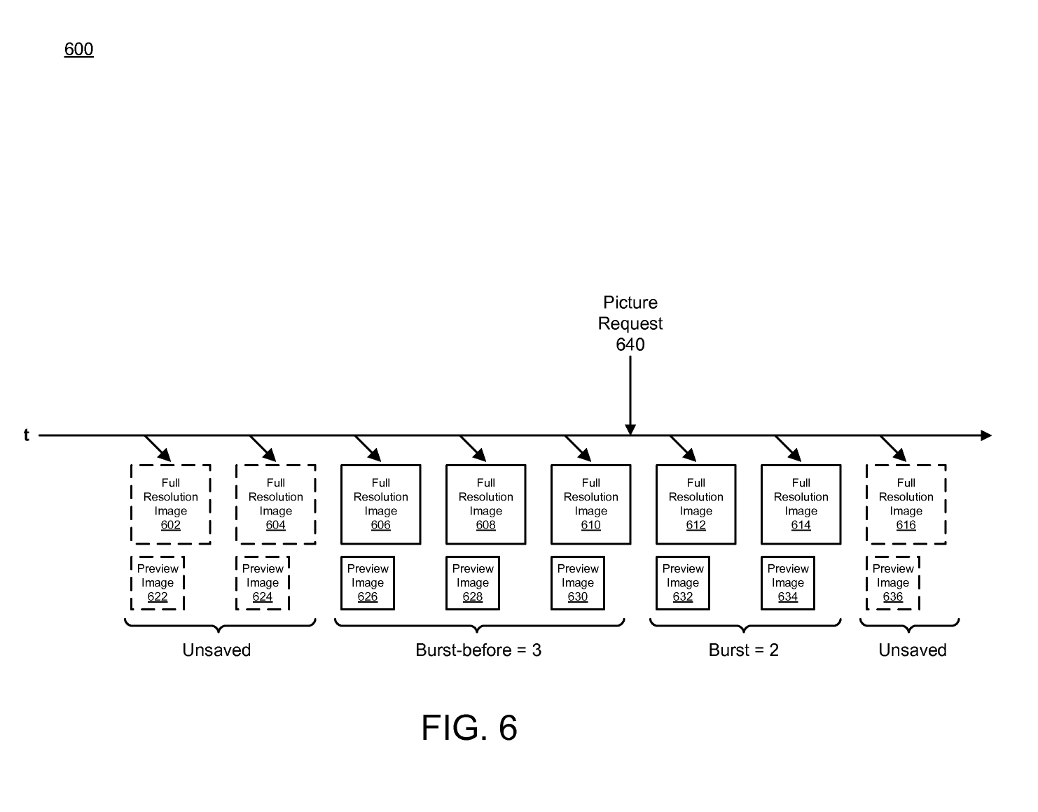

FIG. 6 shows an exemplary time line of exemplary image captures in accordance with one embodiment of the present invention. FIG. 6 depicts a time line of full resolution images captured and preview images generated before and after a take picture request is received. In one embodiment, take picture request 640 is received via a shutter button press via hardware or software (e.g., camera application or API).

Embodiments of the present invention are operable to capture full resolution images (e.g., continually) at a predetermined interval prior to a take picture request (e.g., upon entering a camera mode or negative shutter lag mode). For example, if full resolution image capture is performed at 30 fps and there are three image buffers allocated, every third image capture may be stored in the buffers such that the buffered images are 1/10 of second apart in time. As another example, one of every 30 images captured at a rate of 30 fps may be stored in the buffers, thus making the buffered images one second apart in time.

In one embodiment, the camera configuration comprises a negative-lag-enable, a burst-before-buffer-count setting, and a burst-before setting. The negative-lag-enable feature enables the negative shutter lag feature, as described herein (e.g., invoking process 500). The burst-before-buffer-count setting is the number of frames for the circular buffer (e.g., buffers 420) to allocate and may enable the negative lag feature. The number of buffers actually allocated may be accessed via an API function call (e.g., GetParameter( )).

A camera application may communicate with a driver to set the burst-before-buffer-count which signals the driver of how many buffers or how much memory to use for storing captured images before a shutter button press is received. For example, if the burst-before-buffer-count is set to a non-zero number, the driver determines that the camera application is signaling to activate the negative lag feature. The driver will then change the sensor resolution to the full resolution still capture resolution and then start capturing full resolution images to the buffer(s).

In one embodiment, the buffers are treated as circular buffers such that the oldest image currently in the buffers will be replaced by the newest image captured and the replacement process is then repeated. For example, if there were three buffers, the buffer with the oldest image will be placed at the front of a list and the oldest image will be replaced with the next image captured (e.g., before the shutter button press). The operation of the buffers as circular buffers may operate continuously upon the application signaling to enter a negative shutter lag mode (e.g., a request to allocate buffers).

The burst-before setting is the number of frames of negative lag in a burst (e.g., the number of frames in a burst that were captured and stored prior to the take picture request). The burst setting is the number of images in a burst to be accessed or captured after an image capture request or a picture request.

When a take picture request is received (e.g., takePicture( ) called), the most recent burst-before value of frames will be accessed from the circular buffer (e.g., buffer 420). The remaining frames in the burst may be captured from the sensor as the frames arrive from the sensor or accessed from the buffers as the images are captured. The number of remaining frames may be the number for frames in a burst (e.g., burst setting). For example, if the burst-before setting value is two and the burst setting value is three, a total of five pictures will be captured and presented to a user. Two images will be accessed from the circular buffer (e.g., negative lag images) and three images will either be accessed from the circular buffer or stored directly as the images are captured from the sensor (e.g., after the take picture request).

In one embodiment, a new name-space derived based class of the Android Camera class is created to allow the addition of extensions. The parameters for negative lag capture may be added to the derived class and added to OpenMax IL as extensions. Burst support may be added to the derived class so that it can receive more than one frame of pixels from the Camera HAL (Hardware Abstraction Layer). The camera driver may be altered to support continuous full resolution image capture and to add the negative shutter lag capture functionality.

Referring to FIG. 6, full resolution images 602-610 are captured irrespective of a picture request and before take picture request 640 is received. For example, full resolution images 602-610 may be captured upon the execution of a camera application, entering camera mode of a device, or entering an enhanced image capture mode (e.g., pre-shutter or negative shutter lag mode). Preview images 622-630 are generated from full resolution images 602-610, respectively (e.g., by scaling and rotation module 406) captured before take picture request 640 is received. Full resolution images 612-616 are captured after take picture request 640 is received and preview images 632-636 are generated based on full resolution images 612-616, respectively.

Based on the configuration, some of full resolution images 602-616 may be available for selection to a user. For example, if the burst-before setting value is three and the burst setting value is two, a total of five pictures will be presented to a user with three images from the circular buffer from before picture request 640 (e.g., full resolution images 606-610 or negative lag images) and two images accessed from the buffers or captured by the sensor after picture request 640 (e.g., full resolution images 612-614 captured after the picture request 640). Full resolution images 606-614 may be sent to the encoder (e.g., encoder 408) based on user selection (e.g., via graphical user interfaces 800-900). Full resolution images 602-604 and 616 and corresponding preview images 622-624 and 636 may not be saved or stored to a buffer or buffers based on the burst-before value (e.g., negative shutter lag) of three and burst value of two.

FIG. 7 shows a diagram of an exemplary graphical user interface for image capture and capture configuration in accordance with an embodiment of the present invention. FIG. 7 depicts an exemplary graphical user interface operable for facilitating a user in configuring pre-shutter or negative shutter lag image capture and image capture. Exemplary preview graphical user interface 700 includes image area 702, shutter button 704, pre-shutter or negative shutter lag (NSL) burst count area 706, pre-shutter or NSL skip count area 708, post-shutter burst count area 710, and post-shutter skip count area 712.

Image area 702 is operable to act as a view finder and may comprise preview images viewable by a user. Shutter button 704 is operable for invoking image capture (e.g., a take picture request). In one embodiment, shutter button 704 may be an on screen button.

NSL burst count area 706 is operable for setting the negative shutter lag burst count or the number of frames that are stored (e.g., in a circular buffer) and retained in memory prior to a shutter button press or image capture request (e.g., take picture request). In one embodiment, NSL burst count area 706 comprises on-screen arrows which allow incrementing or decrementing the NSL burst count.

NSL skip count area 708 is operable for setting the negative shutter lag skip count or the number of images that are to be skipped or not stored (e.g., in a circular buffer) during the capturing prior to a shutter button press or image capture request (e.g., a take picture request). For example, if a sensor is operable to capture 30 frames per second (fps) and the NSL skip count is set to five, then every fifth picture captured will be stored (e.g., in a circular buffer) for access after a shutter button press. In other words, the NSL burst count will determine the number of images stored before the shutter button press and the NSL skip count determines the timing between the images stored before the shutter button press.

Post-shutter burst count area 710 is operable for configuring the post-shutter burst count which is the number of images to capture after a shutter button press (e.g., shutter button 704). Post-shutter skip count area 712 is operable for configuring the number of images that are to be skipped or not stored (e.g., in a circular buffer) after a shutter button press or image capture request (e.g., a take picture request). For example, if a sensor is operable to capture 30 frames per second (fps) and the post-shutter skip count is set to five, then every fifth picture captured after the shutter button press will be stored (e.g., in a buffer) for access after a shutter button press. In other words, the post-shutter burst count will determine the number of images stored after the shutter button press and the skip count determines the timing between the images stored before the shutter button press (e.g., images are ⅙ of a second apart in time).

FIGS. 8-9 depict graphical user interfaces that allow a user to select images that were captured before and after the shutter button press for saving (e.g., to a memory card). For example, graphical user interfaces 800 and 900 may allow review and selection of five images captured before a shutter button press and five images captured after the shutter button press. Graphical user interfaces 800 and 900 may be presented after an image capture request based on a shutter button press. Graphical user interfaces 800 and 900 may further allow a user to select images based on focus, exposure, color balance, and desired content (e.g., a home run swing or a goal kick).

FIG. 8 shows a diagram of an exemplary post-capture review graphical user interface in accordance with an embodiment of the present invention. FIG. 8 depicts an exemplary post-capture graphical user interface operable for allowing a user to select images captured before and after the shutter button press for saving or deletion. Exemplary graphical user interface 800 includes preview image area 802. Each preview image of preview image area 802 has a corresponding timestamp and selection icon. Preview image area 802 includes exemplary preview image 804, exemplary time stamp 806, and exemplary selection icons 808-810.

Exemplary preview image 804 comprises selection icon 808 which is operable to allow selection of whether to save or keep. In one embodiment, selection icon 808 allows a user to toggle between marking an image to be saved or discarded. For example, selection icon 808 comprises an ‘x’ indicating that a user does not wish to store the image. Selection icon 810 comprises a checkmark indicating that the user wishes to store the image. The image corresponding to timestamp t=2 comprises a checkmark for the corresponding selection icon indicating that the user wishes to store the image.

Time stamp 806 corresponds to exemplary image 804 which indicates the relative time the image was captured to the shutter button press. Time stamp 806 may indicate the time the image captured relative to the shutter button press in seconds or relative to the number of pre-shutter images captured (e.g., based on the pre-shutter or NSL skip count and NSL burst count). Time t=0 corresponds to the first image captured in response to the shutter button press. The images corresponding time t=−3 through t=−1 correspond to the images captured before the shutter button was pressed and the pre-shutter or NSL burst count. The images corresponding to time t=1 through t=4 correspond to the images captured after the shutter was pressed and post-shutter burst count.

FIG. 9 shows a block diagram of another exemplary post-capture review graphical user interface in accordance with an embodiment of the present invention. FIG. 9 depicts another exemplary graphical user interface for operable allowing a user to select images captured before and after the shutter button press for storing (e.g., to a memory). Exemplary graphical user interface 900 includes preview image area 902, image navigation element 906, and blend button 910.

Image navigation element 906 includes navigation icon or bar 908. In one embodiment, image navigation element 906 is a slider bar with each position on the slider bar representing an image number, memory usage, or distance in time. It is noted image navigation element 906 may be a two axis navigation element. In one embodiment, image navigation element 906 could be based on the amount of memory allocated for image capture before the shutter button press, the number of images, or the duration of time (e.g., 1/50 of a second).

Navigation icon 908 is repositionable or draggable along navigation element 906 by a user and allows a user to navigate through a plurality of preview images. In one embodiment, each of the positions along image navigation element 906 corresponds to a timestamp and corresponding image (e.g., timestamps −3 through 4 of FIG. 8). Preview image area 902 is operable to display a preview image corresponding to a timestamp of image navigation element 906. Preview image area 902 further comprises selection icon 904 which allows a user to toggle between marking an image to be saved or discarded.

Blend button 910 is operable to cause blending to be applied between preview images to smooth out the sequence as a user navigates (e.g., slides) between the preview images.

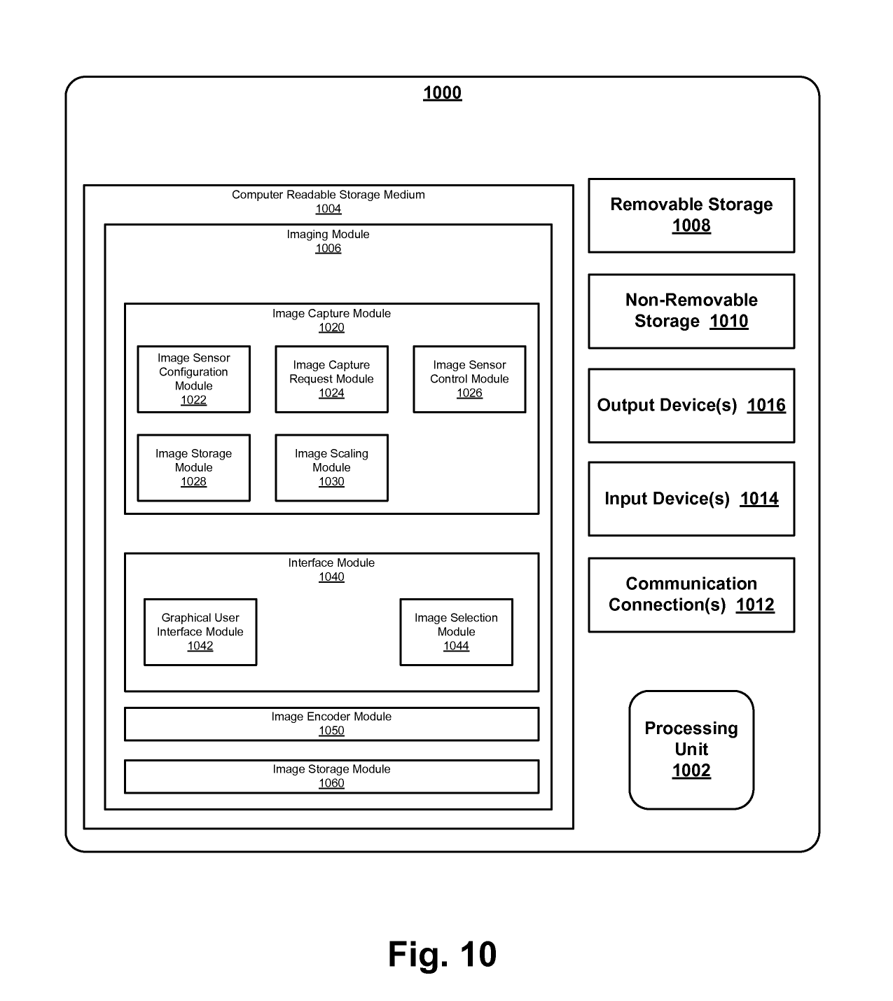

FIG. 10 illustrates example components used by various embodiments of the present invention. Although specific components are disclosed in computing system environment 1000, it should be appreciated that such components are examples. That is, embodiments of the present invention are well suited to having various other components or variations of the components recited in computing system environment 1000. It is appreciated that the components in computing system environment 1000 may operate with other components than those presented, and that not all of the components of system 1000 may be required to achieve the goals of computing system environment 1000.

FIG. 10 shows a block diagram of an exemplary computing system environment 1000, in accordance with one embodiment of the present invention. With reference to FIG. 10, an exemplary system module for implementing embodiments includes a general purpose computing system environment, such as computing system environment 1000. Computing system environment 1000 may include, but is not limited to, servers, desktop computers, laptops, tablet PCs, mobile devices, and smartphones. In its most basic configuration, computing system environment 1000 typically includes at least one processing unit 1002 and computer readable storage medium 1004. Depending on the exact configuration and type of computing system environment, computer readable storage medium 1004 may be volatile (such as RAM), non-volatile (such as ROM, flash memory, etc.) or some combination of the two. Portions of computer readable storage medium 1004 when executed facilitate image capture (e.g., process 500).

Additionally, computing system environment 1000 may also have additional features/functionality. For example, computing system environment 1000 may also include additional storage (removable and/or non-removable) including, but not limited to, magnetic or optical disks or tape. Such additional storage is illustrated in FIG. 10 by removable storage 1008 and non-removable storage 1010. Computer storage media includes volatile and nonvolatile, removable and non-removable media implemented in any method or technology for storage of information such as computer readable instructions, data structures, program modules or other data. Computer readable medium 1004, removable storage 1008 and nonremovable storage 1010 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing system environment 1000. Any such computer storage media may be part of computing system environment 1000.

Computing system environment 1000 may also contain communications connection(s) 1012 that allow it to communicate with other devices. Communications connection(s) 1012 is an example of communication media. Communication media typically embodies computer readable instructions, data structures, program modules or other data in a modulated data signal such as a carrier wave or other transport mechanism and includes any information delivery media. The term computer readable media as used herein includes both storage media and communication media.

Communications connection(s) 1012 may allow computing system environment 1000 to communication over various networks types including, but not limited to, fibre channel, small computer system interface (SCSI), Bluetooth, Ethernet, Wi-fi, Infrared Data Association (IrDA), Local area networks (LAN), Wireless Local area networks (WLAN), wide area networks (WAN) such as the internet, serial, and universal serial bus (USB). It is appreciated the various network types that communication connection(s) 1012 connect to may run a plurality of network protocols including, but not limited to, transmission control protocol (TCP), internet protocol (IP), real-time transport protocol (RTP), real-time transport control protocol (RTCP), file transfer protocol (FTP), and hypertext transfer protocol (HTTP).

Computing system environment 1000 may also have input device(s) 1014 such as a keyboard, mouse, pen, voice input device, touch input device, remote control, etc. Output device(s) 1016 such as a display, speakers, etc. may also be included. All these devices are well known in the art and are not discussed at length.

In one embodiment, computer readable storage medium 1004 includes imaging module 1006. Imaging module 1006 includes image capture module 1020, interface module 1040, image encoder module 1050, and image storage module 1060.

Image capture module 1020 includes image sensor configuration module 1022, image capture request module 1024, image sensor control module 1026, image storage 1028, and image scaling module 1030.

Image sensor configuration module 1022 is operable to configure an image sensor to capture images at a full resolution of the image sensor, as described herein. Image capture request module 1024 is operable to receive an image capture request (e.g., via a shutter button press, camera application, or API), as described herein. Image sensor control module 1026 is operable to signal the image sensor (e.g., image sensor 402) to automatically capture a first image irrespective of a shutter button of a camera and operable to signal the image sensor to capture a second image. As described herein, the first image is captured prior to the image capture request. Image storage module 1028 is operable to control storage of captured images (e.g., into buffers, circular buffers, or other memory).

Image scaling module 1030 is operable to scale images (e.g., full resolution images) to a preview resolution (e.g., for display on a display component having a lower resolution than the full resolution of an image sensor). In one embodiment, image scaling module 1030 is operable to scale the first image and the second image to a second resolution where the second resolution is lower than the full resolution of the sensor.

Interface module 1040 includes graphical user interface module 1042 and image selection module 1044. Graphical user interface module 1042 is operable to generate a graphical user interface (e.g., graphical user interface 700) for configuration of a negative shutter lag image capture mode (e.g., process 500). Image selection module 1044 is operable to generate of a graphical user interface operable for selection of the first image and the second image for at least one of storage and deletion (e.g., graphical user interfaces 800-900).

Image encoder module 1050 is operable to encode (e.g., encoding including formatting and compression) one or more images (e.g., JPEG format).

Image storage module 1060 is operable to store one or more images to storage (e.g., removable storage 1008, non-removable storage 1010, or storage available via communication connection(s) 1012).

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method for image capture, said method comprising:
configuring an image sensor to capture at a full resolution of said image sensor;
automatically capturing a first image with said image sensor irrespective of a shutter button of a camera;
receiving an image capture request, wherein said first image is captured prior to said receiving image capture request;
accessing a second image after said receiving of said image capture request; and
storing said first image and said second image.

2. The method as described in claim 1 further comprising:
displaying said first image and said second image in a graphical user interface, wherein said graphical user interface is operable to allow selection of said first image and said second image for storage.

3. The method as described in claim 1 further comprising:
scaling said first image to a preview resolution, wherein said preview resolution is less than said full resolution of said image sensor.

4. The method as described in claim 1 wherein said image capture request is based on a press of said shutter button.

5. The method as described in claim 1 wherein said image capture request is received from a camera application.

6. The method as described in claim 1 wherein said image capture request is received via an application programming interface (API).

7. The method as described in claim 1 wherein said first image is stored in a circular buffer.

8. A system for image capture, said system comprising:
an image sensor configuration module operable to configure an image sensor to capture at a full resolution of said image sensor;
an image capture request module operable to receive an image capture request; and
an image sensor control module operable to signal said image sensor to automatically capture a first image irrespective of a shutter button of a camera and operable to signal said image sensor to capture a second image, wherein said first image is captured prior to said image capture request.

9. The system as described in claim 8 further comprising:
an image selection module operable to generate a graphical user interface operable for selection of said first image and said second image for at least one of storage and deletion.

10. The system as described in claim 8 further comprising:
a scaling module operable to scale said first image and said second image to a second resolution, wherein said second resolution is lower than said full resolution of said sensor.

11. The system as described in claim 8 wherein said first image is stored in a buffer.

12. The system as described in claim 8 wherein said image capture request module is operable to receive said image capture request from a shutter button.

13. The system as described in claim 8 wherein said image capture request module is operable to receive said image capture request from an application.

14. A computer-readable storage medium having stored thereon, computer executable instructions that, if executed by a computer system cause the computer system to perform a method of capturing a plurality of images, said method comprising:
automatically capturing a first plurality of images with an image sensor operating in a full resolution configuration, wherein said capturing of said first plurality of images is irrespective of a shutter button of a camera;
receiving an image capture request, wherein said first plurality of images is captured prior to receiving said image capture request;
accessing a second plurality of images after said image capture request; and
displaying said first plurality of images and said second plurality of images.

15. The computer-readable storage medium as described in claim 14 wherein said first plurality of images and said second plurality of images are displayed in a graphical user interface operable to allow selection of each image of said first plurality of images and said second plurality of images for storage.

16. The computer-readable storage medium as described in claim 14 wherein said first plurality of images is captured continuously and stored in a circular buffer.

17. The computer-readable storage medium as described in claim 14 wherein said image capture request is based on a shutter button press.

18. The computer-readable storage medium as described in claim 14 wherein said image capture request is received from a camera application.

19. The computer-readable storage medium as described in claim 14 wherein said image capture request is received via an application programming interface (API).

20. The computer-readable storage medium as described in claim 14 wherein a first number of images in said first plurality of image is configurable.
